(19) United States
(12) Patent Application Publication
(10) Pub. No.: US 2021/0183250 A1
(43) Pub. Date: Jun. 17, 2021

(54) CONTROL DEVICE, SYSTEM, PROGRAM, TERMINAL DEVICE, AND CONTROL METHOD

(71) Applicant: Toyota Jidosha Kabushiki Kaisha, Toyota-shi Aichi-ken (JP)

(72) Inventor: Daiki Kaneichi, Tokyo (JP)

(73) Assignee: Toyota Jidosha Kabushiki Kaisha, Toyota-shi Aichi-ken (JP)

(21) Appl. No.: 16/950,102

(22) Filed: Nov. 17, 2020

(30) Foreign Application Priority Data
Dec. 17, 2019 (JP) 2019-227680

(51) Int. Cl. G08G 1/00; G06Q 10/06

(52) U.S. Cl. CPC G08G 1/202; G06Q 10/06311

(57) ABSTRACT

A control device includes a control unit configured to detect vehicle dispatch requirements based on one or more instant messages sent and received among a plurality of users and is configured to create a vehicle dispatch plan that uses a vehicle dispatch service that satisfies the vehicle dispatch requirements by referring to vehicle dispatch service information. The vehicle dispatch requirements are required by at least one user of the plurality of users. The vehicle dispatch service information is provided by at least one vehicle dispatcher.

### CROSS-REFERENCE TO RELATED APPLICATION

This application claims priority to Japanese Patent Application No. 2019-227680 filed on Dec. 17, 2019, incorporated herein by reference in its entirety.

### BACKGROUND

### 1. Technical Field

The present disclosure relates to a control device, a system, a program, a terminal device, and a control method.

### 2. Description of Related Art

Japanese Unexamined Patent Application Publication No. 2002-342426 (JP 2002-342426 A) describes a technique that receives vehicle dispatch request information from a user and sends vehicle dispatch command information to a taxi.

### SUMMARY

The technique described in JP 2002-342426 A cannot provide a vehicle dispatch plan that satisfies a user's requirement.

The present disclosure provides a vehicle dispatch plan that satisfies a user's requirement.

A first aspect of the present disclosure relates to a control device including a control unit. The control unit is configured to detect vehicle dispatch requirements based on one or more instant messages sent and received among a plurality of users and is configured to create a vehicle dispatch plan that uses a vehicle dispatch service that satisfies the vehicle dispatch requirements by referring to vehicle dispatch service information. The vehicle dispatch requirements are required by at least one user of the plurality of users. The vehicle dispatch service information is provided by at least one vehicle dispatcher.

A second aspect of the present disclosure relates to a program that causes a computer to perform an operation. The operation includes receiving a vehicle dispatch plan notification from a control device and outputting the received notification. The control device is configured to detect vehicle dispatch requirements based on one or more instant messages sent and received among a plurality of users and is configured create a vehicle dispatch plan that uses a vehicle dispatch service that satisfies the vehicle dispatch requirements by referring to vehicle dispatch service information. The vehicle dispatch requirements are required by at least one user of the plurality of users. The vehicle dispatch service information is provided by at least one vehicle dispatcher.

A third aspect of the present disclosure relates to a control method including detecting and creating. The detecting, by a control device, detects vehicle dispatch requirements based on one or more instant messages sent and received among a plurality of users. The vehicle dispatch requirements are required by at least one user of the plurality of users. The creating, by the control device, creates a vehicle dispatch plan that uses a vehicle dispatch service that satisfies the vehicle dispatch requirements by referring to vehicle dispatch service information. The vehicle dispatch service information is provided by at least one vehicle dispatcher.

The technique according to the present disclosure can provide a vehicle dispatch plan that satisfies a user's requirement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a block diagram showing a configuration of a control device according to the embodiment of the present disclosure;

FIG. 3 is a block diagram showing a configuration of a server device according to the embodiment of the present disclosure;

FIG. 4 is a block diagram showing a configuration of a terminal device according to the embodiment of the present disclosure;

FIG. 5 is a diagram showing an operation of the system according to the embodiment of the present disclosure;

FIG. 6 is a diagram showing an operation of the system according to the embodiment of the present disclosure;

FIG. 7 is a diagram showing an example of the screen of the terminal device according to the embodiment of the present disclosure;

FIG. 8 is a diagram showing an example of a table that stores vehicle dispatch service information according to the embodiment of the present disclosure;

FIG. 9 is a diagram showing an example of a vehicle dispatch plan according to the embodiment of the present disclosure; and

FIG. 10 is a diagram showing an example of a vehicle dispatch plan according to the embodiment of the present disclosure.

### DETAILED DESCRIPTION OF EMBODIMENTS

An embodiment of the present disclosure will be described below with reference to the drawings.

In the figures, the same reference numerals will be given to the same or similar components. In the description of this embodiment, the description of the same or similar components will be omitted or simplified as appropriate.

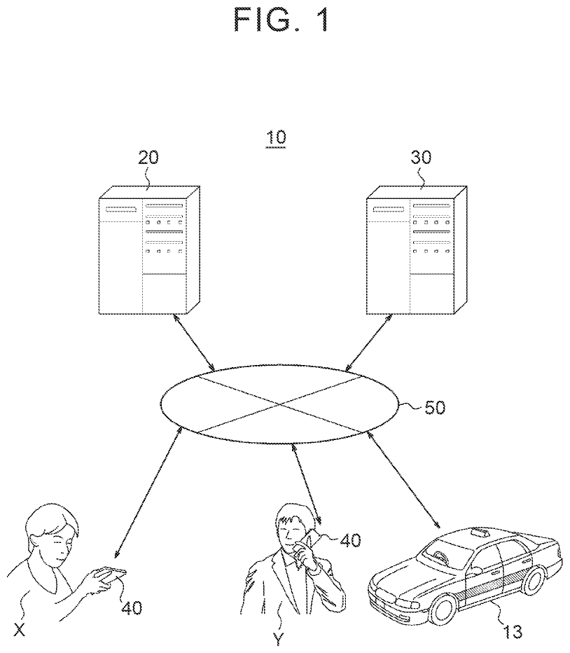

A configuration of a system 10 according to this embodiment will be described with reference to FIG. 1.

The system 10 according to this embodiment includes at least one control device 20, at least one server device 30, terminal devices 40 of a plurality of users (user X and user Y), and a vehicle 13. The plurality of users may include users other than user X and user Y.

The terminal device 40 is carried by a user. The terminal device 40 can communicate with the server device 30 via a network 50 such as a wireless LAN, a mobile communication network, and the Internet. The terminal device 40 may be able to communicate with other terminal devices 40 via the network 50. Each of the terminal devices 40 may be able to communicate with at least one of the control device 20 and the vehicle 13 via the network 50. “LAN” is an abbreviation for local area network.

The server device 30 is an SNS server that provides SNS. The server device 30 can communicate not only with each of the terminal devices 40 but also with the control device 20 via the network 50. The server device 30 may be able to communicate with the vehicle 13 via the network 50. “SNS” is an abbreviation for social networking service.

The control device 20 is a vehicle dispatch server that supports the provision of the vehicle dispatch service provided by least one vehicle dispatcher. The control device 20 is installed, for example, in a facility used only by a vehicle dispatcher or in a facility, such as a data center, shared by a plurality of users.

The control device 20 may be able to communicate not only with the terminal device 40 and the server device 30 but also with the vehicle 13 via the network 50.

Although a taxi in this embodiment, the vehicle 13 may be an automobile other than a taxi, such as an on-demand bus, as long as the automobile can carry at least one of user X and user Y. The vehicle 13 is any type of automobile such as a gasoline vehicle, a diesel vehicle, an HV, a PHV, an EV, or an FCV. “HV” is an abbreviation for hybrid vehicle. “PHV” is an abbreviation for plug-in hybrid vehicle. “EV” is an abbreviation for electric vehicle. “FCV” is an abbreviation for fuel cell vehicle. Although driven by a driver in this embodiment, the vehicle 13 may be autonomously driven at any autonomous driving level. The autonomous driving level is, for example, one of the SAE autonomous driving levels 1 to 5. “SAE” is an abbreviation for Society of Automotive Engineers. The vehicle 13 may be a MaaS vehicle. “MaaS” is an abbreviation for Mobility as a Service.

An outline of this embodiment will be described with reference to FIG. 1.

In the system 10 shown in FIG. 1, the control device 20 detects vehicle dispatch requirements required by at least one of a plurality of users based on one or more instant messages sent and received among the plurality of users. When such vehicle dispatch requirements are detected, the control device 20 refers to the vehicle dispatch service information, provided by at least one vehicle dispatcher, and creates a vehicle dispatch plan that uses the vehicle dispatch service satisfying the vehicle dispatch requirements.

According to this embodiment, the control device 20 detects vehicle dispatch requirements required by at least one user based on one or more instant messages sent and received among a plurality of users. After that, the control device 20 creates a dispatch plan that uses a vehicle dispatch service satisfying the vehicle dispatch requirements, providing a vehicle dispatch plan that satisfies the user's requirements.

“Vehicle dispatch requirements” are requirements that are premises or constraints when a user requests a vehicle dispatch. More specifically, “vehicle dispatch requirements” include the vehicle type, number of passengers, pick-up place, pick-up time, or drop-off place required by the user who requests a vehicle dispatch.

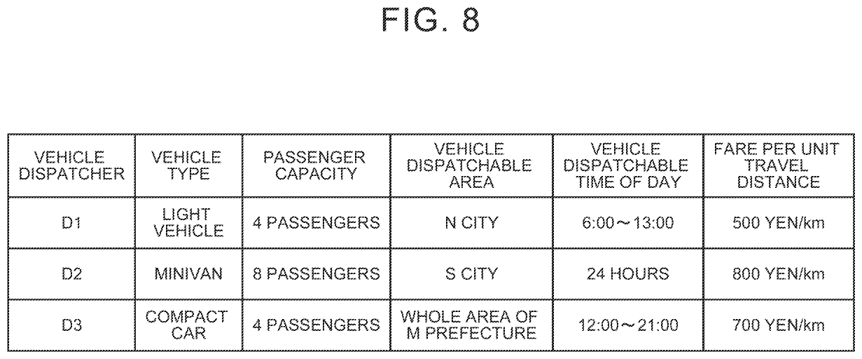

The “vehicle dispatch service information” may be any information that indicates the vehicle dispatch services provided by at least one vehicle dispatcher. In this embodiment, the “vehicle dispatch service information” is the information on the vehicle dispatch services provided by a plurality of vehicle dispatchers. The “vehicle dispatch service information” may be stored in any form. In this embodiment, the “vehicle dispatch service information” is stored in a database, more specifically, in the table shown in FIG. 8. In this table, for each of a plurality of vehicle dispatchers, the vehicle type, passenger capacity, vehicle dispatchable area, vehicle dispatchable time of day, and fare per unit travel distance of the vehicles 13 owned by the vehicle dispatches are stored as the “vehicle dispatch service information”. Each row of the table constitutes one record.

A “vehicle dispatch plan” is a plan to transport a user created for satisfying the vehicle dispatch requirements required by the user. A “vehicle dispatch plan” includes at least one of the vehicle type, number of passengers, pick-up place, pick-up time, drop-off place, and estimated arrival time of the vehicle 13 to be dispatched. In addition, a vehicle dispatch plan may include at least one of the estimated amount of fare and the required time.

The server device 30, configured as an SNS server, searches the instant messages exchanged between a plurality of users participating in an SNS chat and, based on this search, determines whether it is necessary to dispatch a taxi. The server device 30 may cause the vehicle dispatcher bot, which is a chat bot managed by at least one vehicle dispatcher, to interrupt a chat. By causing the vehicle dispatcher bot to interrupt a chat, the server device 30 may send an instant message to the user to inquire about the user's requirements and, based on a response to this instant message, to detect user's requirements.

The control device 20, configured as a vehicle dispatch server, creates a vehicle dispatch plan according to instant messages exchanged in an SNS chat. More specifically, the control device 20 creates a vehicle dispatch plan based on the requirements of at least one of a plurality of users participating in a chat. To create a vehicle dispatch plan, the control device 20 detects vehicle dispatch requirements, which are the requirements of at least one of a plurality of users participating in the chat, from the instant messages exchanged in an SNS chat. For example, the control device 20 reads the text and stamps included in the instant messages, analyzes the content of the chat, and detects the vehicle dispatch requirements required by the user. After that, the control device 20 creates a vehicle dispatch plan that uses a vehicle dispatch service satisfying the detected vehicle dispatch requirements. The control device 20 may propose a multimodal route that include not only a taxi but also a combination of various methods of transportation such as walking, a bicycle, a bus, a rental car, a private car, a railroad, or an airplane.

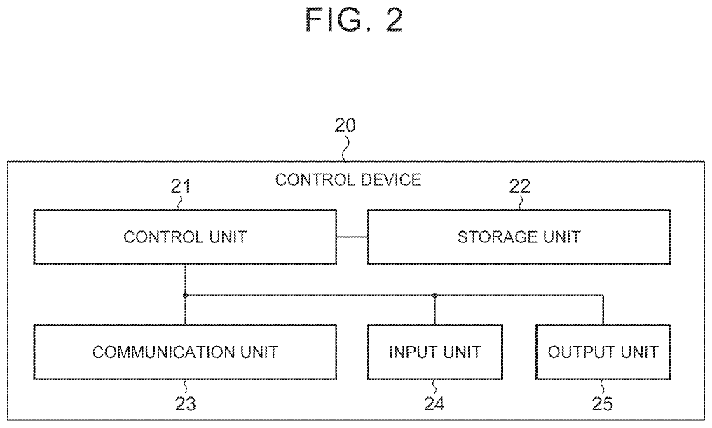

A configuration of the control device 20 according to this embodiment will be described with reference to FIG. 2.

The control device 20 is configured as a vehicle dispatch server in this embodiment. The vehicle dispatch server is, for example, a server in a cloud computing system or other computing systems.

The control device 20 includes a control unit 21, a storage unit 22, a communication unit 23, an input unit 24, and an output unit 25.

The control unit 21 includes at least one processor, at least one dedicated circuit, or a combination of them. The processor is a general-purpose processor, such as a CPU or a GPU, or a dedicated processor specialized for specific processing. “CPU” is an abbreviation for central processing unit. “GPU” is an abbreviation for graphics processing unit. The dedicated circuit is, for example, an FPGA or an ASIC. “FPGA” is an abbreviation for field-programmable gate array. “ASIC” is an abbreviation for application specific integrated circuit. The control unit 21 performs the processing related to the operation of the control device 20 while controlling the units of the control device 20,

The storage unit 22 includes at least one semiconductor memory, at least one magnetic memory, at least one optical memory, or a combination of at least two of these memories. The semiconductor memory is, for example, a RAM or a ROM. “RAM” is an abbreviation for random access memory. “ROM” is an abbreviation for read only memory. The RAM is, for example, an SRAM or a DRAM. “SRAM” is an abbreviation for static random access memory. “DRAM” is an abbreviation for dynamic random access memory. The ROM is, for example, an EEPROM. “EEPROM” is an abbreviation for electrically erasable programmable read only memory. The storage unit 22 functions, for example, as a main storage device, an auxiliary storage device, or a cache memory. The storage unit 22 stores data used for the operation of the control device 20 and data obtained by the operation of the control device 20. Although stored in the storage unit 22 in this embodiment, the table shown in FIG. 8 may be stored in an external memory or the like.

The communication unit 23 includes at least one communication interface. The communication interface is, for example, a LAN interface. The communication unit 23 receives data used for the operation of the control device 20 and sends data obtained by the operation of the control device 20.

The input unit 24 includes at least one input interface. The input interface is, for example, physical keys, capacitive keys, a pointing device, a touch screen integrated with a display, or a microphone. The input unit 24 receives an operation to enter data used for an operation of the control device 20. Instead of being provided in the control device 20, the input unit 24 may be connected to the control device 20 as an external input device. In this case, for connection to the control device 20, any of USB, HDMI (registered trademark), or Bluetooth (registered trademark) may be used. “USB” is an abbreviation for Universal Serial Bus. “HDMI (registered trademark)” is an abbreviation for High-Definition Multimedia Interface.

The output unit 25 includes at least one output interface. The output interface is, for example, a display or a speaker. The display is, for example, an LCD or an organic EL display. “LCD” is an abbreviation for liquid crystal display. “EL” is an abbreviation for electro luminescence. The output unit 25 outputs data obtained by the operation of the control device 20. Instead of being provided in the control device 20, the output unit 25 may be connected to the control device 20 as an external output device. In this case, for connection to the control device 20, any of USB, HDMI (registered trademark), or Bluetooth (registered trademark) may be used.

The function of the control device 20 is implemented when the processor corresponding to the control unit 21 executes the control program according to this embodiment. That is, the function of the control device 20 is implemented by software. The control program causes the computer to perform the operation of the control device 20 to allow the computer to function as the control device 20. That is, the computer functions as the control device 20 by performing the operation of the control device 20 according to the control program.

The program can be recorded in a computer-readable recording medium. The computer-readable recording medium is, for example, a magnetic recording device, an optical disc, a magneto-optical recording medium, or a semiconductor memory. The program is distributed, for example, by selling, transferring, or lending a portable recording medium such as a DVD or a CD-ROM in which the program is recorded. “DVD” is an abbreviation for digital versatile disc. “CD-ROM” is an abbreviation for compact disc read only memory. The program may also be distributed by storing it in the storage of the server and then transferring the program from the server to another computer. The program may be provided as a program product.

The computer stores the program, recorded in the portable recording medium or transferred from the server, once in the main storage device. Then, the computer causes the processor to read the program from the main storage device and causes the processor to perform processing according to the program that has been read. The computer may also read the program directly from a portable recording medium and perform processing according to the program. The computer may also perform processing sequentially according to the received program each time the program is transferred from the server to the computer. Furthermore, instead of transferring the program from the server to the computer, the computer may perform processing by the so-called application service provider (ASP) service. In the ASP service, the function is implemented only by issuing an execution instruction and then acquiring the result. “ASP” is an abbreviation for application service provider. The program includes program-like information that is used for processing by an electronic computer. For example, data that is not a command directly sent to a computer but has the property of defining the processing of the computer is “program-like information”.

A part or all of the functions of the control device 20 may be implemented by a dedicated circuit corresponding to the control unit 21. That is, a part or all of the functions of the control device 20 may be implemented by hardware.

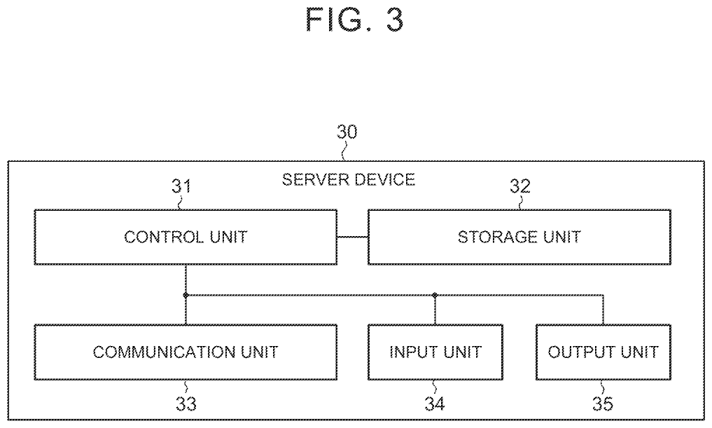

A configuration of the server device 30 according to this embodiment will be described with reference to FIG. 3.

The server device 30 is configured as an SNS server in this embodiment. The SNS server is, for example, a server in a cloud computing system or other computing systems.

The server device 30 includes a control unit 31, a storage unit 32, a communication unit 33, an input unit 34, and an output unit 35.

The control unit 31 includes at least one processor, at least one dedicated circuit, or a combination of them. The processor is a general-purpose processor, such as a CPU or a GPU, or a dedicated processor specialized for specific processing. The dedicated circuit is, for example, an FPGA or an ASIC. The control unit 31 performs processing related to the operation of the server device 30 while controlling the units of the server device 30.

The storage unit 32 includes at least one semiconductor memory, at least one magnetic memory, at least one optical memory, or a combination of at least two of these memories. The semiconductor memory is, for example, a RAM or a ROM. The RAM is, for example, an SRAM or a DRAM. The ROM is, for example, an EEPROM. The storage unit 32 functions, for example, as a main storage device, an auxiliary storage device, or a cache memory. The storage unit 32 stores data used for the operation of the server device 30 and data obtained by the operation of the server device 30.

The communication unit 33 includes at least one communication interface. The communication interface is, for example, a LAN interface. The communication unit 33 receives data used for the operation of the server device 30 and sends data obtained by the operation of the server device 30.

The input unit 34 includes at least one input interface. The input interface is, for example, physical keys, capacitive keys, a pointing device, a touch screen integrated with a display, or a microphone. The input unit 34 receives an input operation to enter data used for the operation of the server device 30. Instead of being provided in the server device 30, the input unit 34 may be connected to the server device 30 as an external input device. In this case, for connection to the server device 30, any of USB, HDMI (registered trademark), or Bluetooth (registered trademark) may be used.

The output unit 35 includes at least one output interface. The output interface is, for example, a display or a speaker. The display is, for example, an LCD or an organic EL display. The output unit 35 outputs data obtained by the operation of the server device 30. Instead of being provided in the server device 30, the output unit 35 may be connected to the server device 30 as an external output device. In this case, for connection to the server device 30, any of USB, HDMI (registered trademark), or Bluetooth (registered trademark) may be used.

The function of the server device 30 is implemented when the processor corresponding to the control unit 31 executes the server program according to this embodiment. That is, the function of the server device 30 is implemented by software. The server program causes the computer to perform the operation of the server device 30 to allow the computer to function as the server device 30. That is, the computer functions as the server device 30 by performing the operation of the server device 30 according to the server program.

A part or all of the functions of the server device 30 may be implemented by a dedicated circuit corresponding to the control unit 31. That is, a part or all of the functions of the server device 30 may be implemented by hardware.

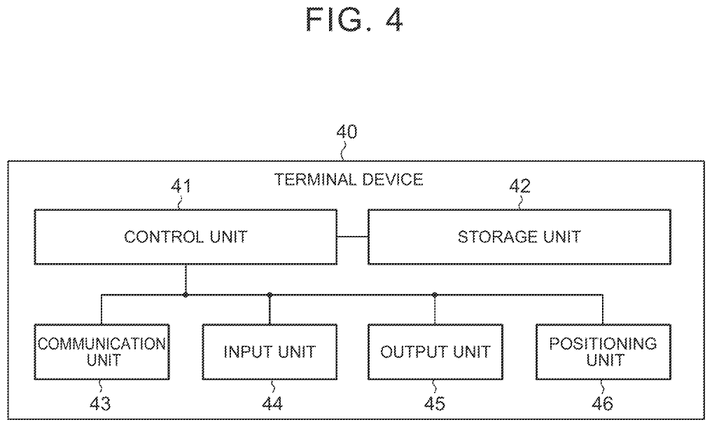

A configuration of the terminal device 40 according to this embodiment will be described with reference to FIG. 4.

The terminal device 40 is configured as a user terminal in this embodiment. The terminal device 40 is, for example, a mobile phone, a smartphone, a tablet, or a PC. “PC” is an abbreviation for personal computer.

The terminal device 40 includes a control unit 41, a storage unit 42, a communication unit 43, an input unit 44, an output unit 45, and a positioning unit 46.

The control unit 41 includes at least one processor, at least one dedicated circuit, or a combination of them. The processor is a general-purpose processor, such as a CPU or a GPU, or a dedicated processor specialized for specific processing. The dedicated circuit is, for example, an FPGA or an ASIC. The control unit 41 performs processing related to the operation of the terminal device 40 while controlling the units of the terminal device 40.

The storage unit 42 includes at least one semiconductor memory, at least one magnetic memory, at least one optical memory, or a combination of at least two of these memories. The semiconductor memory is, for example, a RAM or a ROM. The RAM is, for example, an SRAM or a DRAM. The ROM is, for example, an EEPROM. The storage unit 42 functions, for example, as a main storage device, an auxiliary storage device, or a cache memory. The storage unit 42 stores data used for the operation of the terminal device 40 and data obtained by the operation of the terminal device 40.

The communication unit 43 includes at least one communication interface. The communication interface is, for example, an interface corresponding to the LTE, 4G, or 5G mobile communication standard, an interface corresponding to a short-range wireless communication standard such as Bluetooth (registered trademark), or a LAN interface. “LTE” is an abbreviation for Long Term Evolution. “4G” is an abbreviation for 4th generation. “5G” is an abbreviation for 5th generation. The communication unit 33 receives data used for the operation of the terminal device 40 and sends data obtained by the operation of the terminal device 40.

The input unit 44 includes at least one input interface. The input interface is, for example, physical keys, capacitive keys, a pointing device, a touch screen integrated with a display, or a microphone. The input unit 44 receives an input operation to enter data used for the operation of the terminal device 40. Instead of being provided in the terminal device 40, the input unit 44 may be connected to the terminal device 40 as an external input device. In this case, for connection to the terminal device 40, any of USB, HDMI (registered trademark), or Bluetooth (registered trademark) may be used.

The output unit 45 includes at least one output interface. The output interface is, for example, a display or a speaker. The display is, for example, an LCD or an organic EL display. The output unit 45 outputs data obtained by the operation of the terminal device 40. Instead of being provided in the terminal device 40, the output unit 45 may be connected to the terminal device 40 as an external output device. In this case, for connection to the terminal device 40, any of USB, HDMI (registered trademark), or Bluetooth (registered trademark) may be used.

The positioning unit 46 includes at least one GNSS receiver. “GNSS” is an abbreviation for global navigation satellite system. The GNSS includes, for example, at least one of GPS, QZSS, GLONASS, and Galileo. “GPS” is an abbreviation for Global Positioning System. “QZSS” is an abbreviation for Quasi-Zenith Satellite System. A QZSS satellite is called a quasi-zenith satellite. “GLONASS” is an abbreviation for Global Navigation Satellite System. The positioning unit 46 measures the position of the terminal device 40.

The function of the terminal device 40 is implemented when the processor corresponding to the control unit 41 executes the terminal program according to this embodiment. That is, the function of the terminal device 40 is implemented by software. The terminal program causes the computer to perform the operation of the terminal device 40 to allow the computer to function as the terminal device 40. That is, the computer functions as the terminal device 40 by performing the operation of the terminal device 40 according to the terminal program.

A part or all of the functions of the terminal device 40 may be implemented by a dedicated circuit corresponding to the control unit 41. That is, a part or all of the functions of the terminal device 40 may be implemented by hardware.

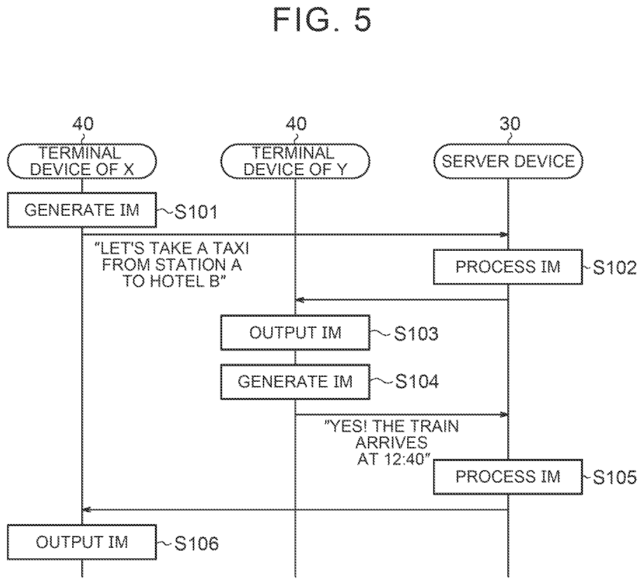

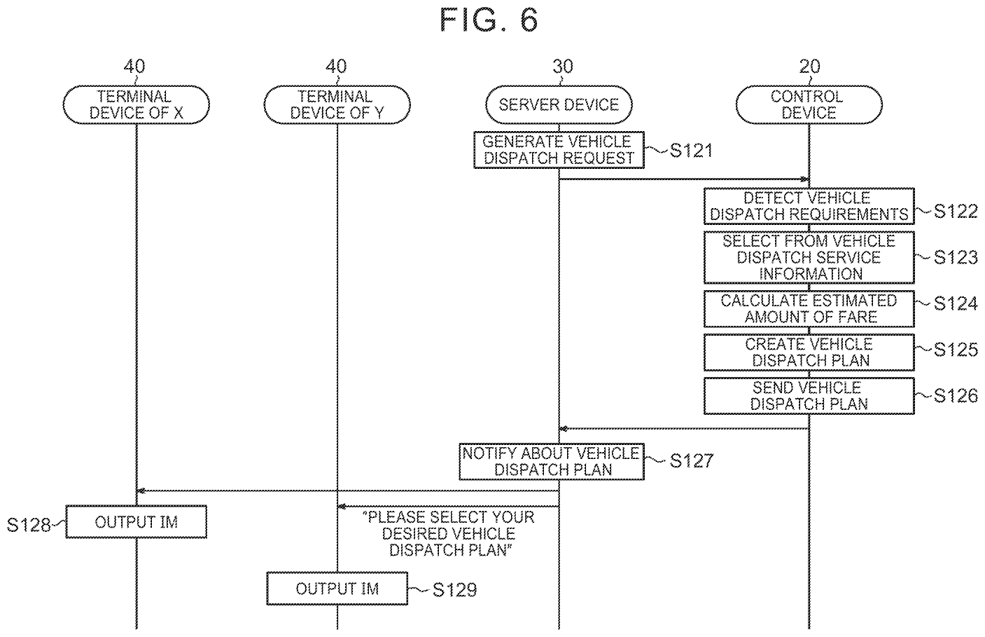

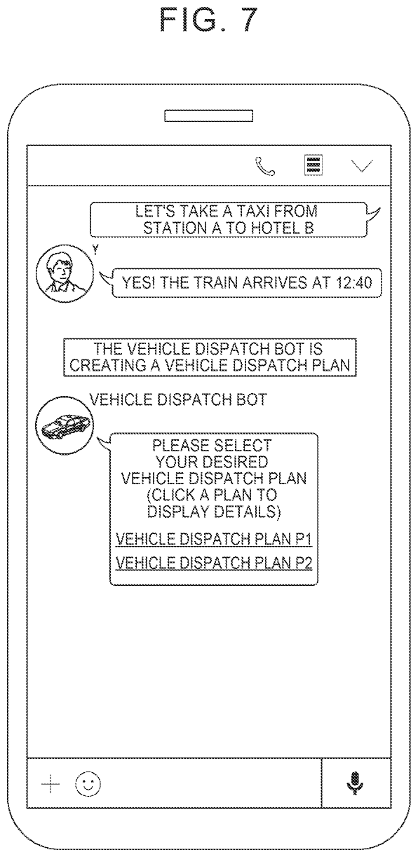

The operation of the system 10 according to this embodiment will be described with reference to FIG. 5 to FIG. 7. This operation corresponds to the control method according to this embodiment. In FIG. 5 and FIG. 6, “IM” means an instant message.

It is assumed, in a practical example given below, that user X and user Y send and receive instant messages to each other to have an SNS chat. It is also assumed that the vehicle 13 is a taxi. A “practical example” is illustrated here to aid the understanding of this embodiment, not to limit the present disclosure.

In step S101, the control unit 41 of the terminal device 40 of user X receives an input operation of user X to enter a text addressed to user Y via the input unit 44. The control unit 41 generates an instant message including the entered text. The control unit 41 sends the generated instant message to the server device 30 via the communication unit 43.

In this example, user X enters a text “Let's take a taxi from station A to hotel B” into the terminal device 40. The control unit 41 of the terminal device 40 sends an instant message, which includes the entered text, to the server device 30.

In step S102, the control unit 31 of the server device 30 receives the instant message, sent in step S101, via the communication unit 33. The control unit 31 sends the received instant message to the terminal device 40 of user Y via the communication unit 33 and, at the same time, processes the received instant message. More specifically, the control unit 31 of the server device 30 processes the received instant message in the same way as the control unit 31 processes a chat on the conventional SNS and, at the same time, analyzes the content of the received instant message to determine whether user X requires the dispatch of a vehicle.

In this example, the control unit 31 of the server device 30 transfers the instant message, which includes the text “Let's take a taxi from station A to hotel B”, from the terminal device 40 of user X to the terminal device 40 of user Y. From the message “Let's take a taxi from station A to hotel B”, the control unit 31 of the server device 30 can determine that user X requires a taxi from station A to hotel B. The control unit 31 of the server device 30 saves the instant message, which includes the text “Let's take a taxi from station A to hotel B”, in the storage unit 32 as a first instant message.

In step S103, the control unit 41 of the terminal device 40 of user Y receives the instant message, sent in step S102, via the communication unit 43. The control unit 41 displays the received instant message on the screen via the output unit 45.

In this example, the control unit 41 of the terminal device 40 of user Y receives the instant message, which includes the text “Let's take a taxi from station A to hotel B”, from the server device 30. The control unit 41 of the terminal device 40 displays the received instant message to user Y.

In step S104, the control unit 41 of the terminal device 40 of user Y receives an operation of user Y to enter a text addressed to user X via the input unit 44. The control unit 41 generates an instant message that includes the entered text. The control unit 41 sends the generated instant message to the server device 30 via the communication unit 43.

In this example, user Y enters a text “Yes! The train arrives at 12:40” into the terminal device 40. The control unit 41 of the terminal device 40 sends an instant message that includes the entered text to the server device 30.

In step S105, the control unit 31 of the server device 30 receives the instant message, sent in step S104, via the communication unit 33. The control unit 31 sends the received instant message to the terminal device 40 of user X via the communication unit 33 and, at the same time, processes the received instant message. More specifically, the control unit 31 of the server device 30 processes the received instant message in the same way as the control unit 31 processes a chat on the conventional SNS and, at the same time, analyzes the content of the received instant message in the same way as in the processing in step S102.

In this example, the control unit 31 of the server device 30 transfers the instant message, which includes the text “Yes! The train arrives at 12:40”, from the terminal device 40 of user Y to the terminal device 40 of user X. In response to the message “Let's take a taxi from station A to hotel B”, the message “Yes! The train arrives at 12:40” is returned. From these messages, it can be determined that user X and user Y want to get together at the station and, from there, use a taxi. Therefore, the control unit 31 of the server device 30 determines that it is necessary to dispatch the vehicle 13 to transport user X and user Y. The control unit 31 of the server device 30 saves the instant message received from user Y, which includes the text “Yes! The train arrives at 12:40” in the storage unit 32 as a second instant message.

In step S106, the control unit 41 of the terminal device 40 of user X receives the instant message, sent in step S105, via the communication unit 43. The control unit 41 displays the received instant message on the screen via the output unit 45.

In this example, the control unit 41 of the terminal device 40 of user X receives the instant message, which includes the text “Yes! The train arrives 12:40”, from the server device 30. The control unit 41 of the terminal device 40 displays the received instant message to user X.

When the control unit 31 of the server device 30 determines in step S105 that it is necessary to dispatch the vehicle 13 to transport user X and user Y, the control unit 31 causes both the terminal device 40 of user X and the terminal device 40 of user Y to display a message indicating that a vehicle dispatch plan is being created. More specifically, the control unit 31 of the server device 30 causes both the terminal device 40 of user X and the terminal device 40 of user Y to display a system message such as “The vehicle dispatch bot is creating a vehicle dispatch plan”. By displaying such a system message, user X and user Y are less likely to feel that the plan is proposed suddenly when a vehicle dispatch plan for carrying user X and user Y is proposed. In step S121, the control unit 31 of the server device 30 acquires the first instant message, saved in the storage unit 32 in step S102, and the second instant message saved in the storage unit 32 in step S105. The control unit 31 generates a vehicle dispatch request that includes the first instant message and the second instant message that have been acquired. The control unit 31 sends the generated vehicle dispatch request to the control device 20 via the communication unit 33.

In this example, the control unit 31 of the server device 30 generates a vehicle dispatch request. This vehicle dispatch request includes the instant message, which includes the text “Let's take a taxi from station A to hotel B” received from user X, and the instant message that includes the text “Yes! The train arrives at 12:40” received from user Y. The control unit 31 sends the generated vehicle dispatch request to the control device 20 as a vehicle dispatch request from user X and user Y.

In step S122, the control unit 21 of the control device 20 receives the vehicle dispatch request, sent in step S121, via the communication unit 23. Then, the control unit 21 detects the vehicle dispatch requirements of user X and user Y, based on the first instant message and the second instant message included in the received vehicle dispatch request. More specifically, the control unit 21 analyzes the content of the instant messages included in the received vehicle dispatch request and detects the vehicle dispatch requirements required by user X and user Y. More specifically, from the text included in the first instant message and the second instant message, the control unit 21 detects predetermined keywords as the vehicle dispatch requirements required by at least one of user X and user Y.

In this example, from the text “Let's take a taxi from station A to hotel B” included in the instant message received from user X, the control unit 21 of the control device 20 detects the keywords “station A” and “hotel B” as the vehicle dispatch requirements required by user X. That is, the control unit 21 detects “station A” as the pick-up place that is one of the vehicle dispatch requirements, and detects “hotel B” as the drop-off place that is one of the vehicle dispatch requirements. Similarly, from the text “Yes! The train arrives at 12:40” included in the instant message received from user Y, the control unit 21 detects the keyword “12:40” as the vehicle dispatch requirements required by user Y. That is, the control unit 21 detects “12:40” as the pick-up time that is one of the vehicle dispatch requirements.

In step S123, the control unit 21 of the control device 20 refers to the vehicle dispatch service information provided by a plurality of vehicle dispatchers to create the content of a vehicle dispatch plan that uses a vehicle dispatch service satisfying the vehicle dispatch requirements detected in step 122. More specifically, from the table that stores the vehicle dispatch service information, the control unit 21 selects a record that satisfies the detected vehicle dispatch requirements. The control unit 21 creates the content of a vehicle dispatch plan that uses the vehicle dispatch service indicated by the selected record.

In this example, the control unit 21 of the control device 20 refers to the table shown in FIG. 8. This table stores the content of the vehicle dispatch services, provided by each of a plurality of the vehicle dispatchers (vehicle dispatcher D1, vehicle dispatcher D2, and vehicle dispatcher D3), as the “vehicle dispatch service information”. In this table, the content of the vehicle dispatch services is classified into “vehicle type”, “passenger capacity”, “vehicle dispatchable area”, “vehicle dispatchable time of day”, and “fare per unit travel distance” of the vehicle 13, each of which is stored in the corresponding column of the table. The values stored in the “vehicle dispatchable area” column, “vehicle dispatchable time of day” column, and “fare per unit travel distance” column of this table may be static values or dynamically changing values. These values may be dynamically changed according to probe data such as the current position of each vehicle or according to the current time (daytime fare or late-night fare) and the like. “N city” and “Whole area of M prefecture”, which are values stored in the “vehicle dispatchable area” column, are assumed to include the pick-up place of “station A” and the drop-off place of “Hotel B” that have been detected in step S122 as the vehicle dispatch requirements. “6:00 to 13:00” and “12:00 to 21:00”, which are values stored in the “vehicle dispatchable time of day” column, include the pick-up time of “12:40” that has been detected in step S122 as the vehicle dispatch requirements. Therefore, the control unit 21 selects the records of vehicle dispatcher D1 and vehicle dispatcher D3.

In step S124, the control unit 21 of the control device 20 calculates the estimated amount of fare based on the vehicle dispatch requirements detected in step S122 and based on the fare per unit travel distance included in the record selected in step S123. More specifically, the control unit 21 calculates the distance from the pick-up place to the drop-off place, both of which are included in the vehicle dispatch requirements detected in step S122. Then, the control unit 21 multiples the calculated distance by the fare per unit travel distance included in the record selected in step S123 to calculate the estimated amount of fare.

In this example, the control unit 21 multiplies the distance from “station A” (pick-up place) to “hotel B” (drop-off place), both of which are included in the vehicle dispatch requirements, by 500 yen/km (fare per unit travel distance), which is included in the record of the vehicle dispatcher D1, to calculate the estimated amount of fare of the vehicle dispatch service provided by vehicle dispatcher D1. Similarly, the control unit 21 multiples the distance from “station A” (pick-up place) to “hotel B” (drop-off place), both of which are included in the vehicle dispatch requirements, by 700 yen/km (fare per unit travel distance), which is included in the record of vehicle dispatcher D3, to calculate the estimated amount of fare of the vehicle dispatch service provided by vehicle dispatcher D3.

In step S125, the control unit 21 of the control device 20 creates a vehicle dispatch plan.

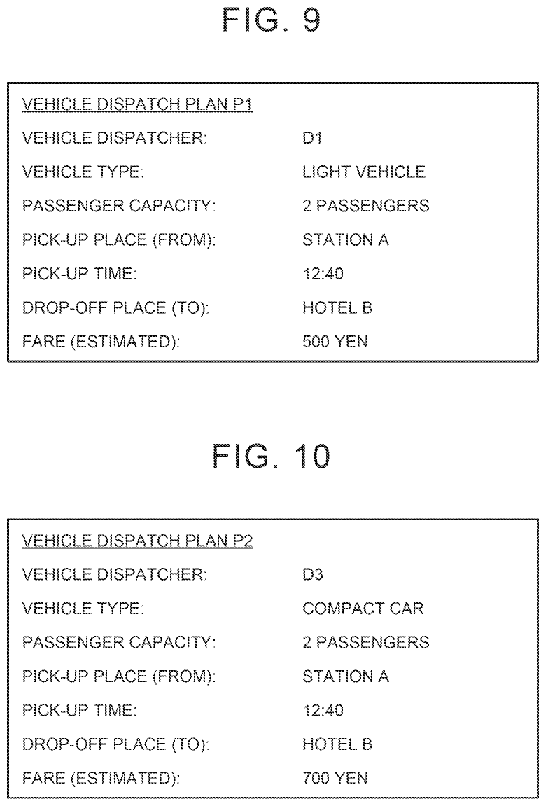

In this example, the control unit 21 of the control device 20 creates vehicle dispatch plan P1 such as the one shown in FIG. 9 and vehicle dispatch plan P2 such as the one shown in FIG. 10. Each of these dispatch plans includes the content of the vehicle dispatch service described in the record selected in step S123 and the estimated amount of fare calculated in step S124. Vehicle dispatch plan P1 is a vehicle dispatch plan created for vehicle dispatcher D1. Vehicle dispatch plan P2 is a vehicle dispatch plan created for vehicle dispatcher D3.

In step S126, the control unit 21 of the control device 20 sends the vehicle dispatch plans, created in step S125, to the server device 30 via the communication unit 23.

In this example, the control unit 21 of the control device 20 sends vehicle dispatch plan P1 and vehicle dispatch plan P2, each including the estimated amount of fare, to the server device 30.

In step 127, the control unit 31 of the server device 30 receives the vehicle dispatch plans, sent in step S126, via the communication unit 33. The control unit 31 generates an instant message to notify about the received vehicle dispatch plans. The control unit 31 sends the generated instant message to both the terminal device 40 of user X and the terminal device 40 of user Y via the communication unit 33.

In this example, the control unit 31 of the server device 30 receives vehicle dispatch plan P1 and vehicle dispatch plan P2. The control unit 31 creates a message prompting the user to select a vehicle dispatch plan. More specifically, the control unit 31 creates an instant message including the text “Please select your desired vehicle dispatch plan” and the URLs of vehicle dispatch plan P1 and vehicle dispatch plan P2. “URL” is an abbreviation for uniform resource locator. The control unit 31 sends the created instant message to both the terminal device 40 of user X and the terminal device 40 of user Y.

In step S128, the terminal device 40 of user X receives the vehicle dispatch plan notification from the server device 30 and outputs the received vehicle dispatch plan notification. More specifically, the control unit 41 of the terminal device 40 of user X receives the instant message, sent in step S127, via the communication unit 43. The control unit 41 displays the received instant message on the screen via output unit 45.

In this example, the control unit 41 of the terminal device 40 of user X receives the instant message, which includes the text “Please select your desired vehicle dispatch plan” and the URLs of vehicle dispatch plan P1 and vehicle dispatch plan P2, from the server device 30. The control unit 41 of the terminal device 40 displays to user X the text “Please select your desired vehicle dispatch plan” and the URLs of the vehicle dispatch plan P1 and vehicle dispatch plan P2 included in the received instant message. When user X clicks the URL of vehicle dispatch plan P1, the browser is activated and the details of vehicle dispatch plan P1 are displayed as shown in FIG. 9. When user X clicks the URL of vehicle dispatch plan P2, the browser is activated and the details of vehicle dispatch plan P2 are displayed as shown in FIG. 10.

In step S129, the terminal device 40 of user Y receives the vehicle dispatch plan notification from the server device 30 and outputs the received vehicle dispatch plan notification. More specifically, the control unit 41 of the terminal device 40 of user Y receives the instant message, sent in step S127, via the communication unit 43. The control unit 41 displays the received instance message on the screen via the output unit 45.

In this example, the control unit 41 of the terminal device 40 of user Y receives the instant message, which includes the text “Please select your desired vehicle dispatch plan”, as well as the URLs of vehicle dispatch plan P1 and vehicle dispatch plan P2, from the server device 30. The control unit 41 of the terminal device 40 displays to user Y the text “Please select your desired vehicle dispatch plan” and the URLs of vehicle dispatch plan P1 and vehicle dispatch plan P2 included in the received instant message. When user Y clicks the URL of vehicle dispatch plan P1, the browser is activated and the details of vehicle dispatch plan P1 are displayed as shown in FIG. 9. Similarly, when user Y clicks the URL of vehicle dispatch plan P2, the browser is activated and the details of vehicle dispatch plan P2 are displayed as shown in FIG. 10.

In this embodiment, the control unit 21 of the control device 20 detects the vehicle dispatch requirements, required by at least one of a plurality of users, based on one or more instant messages sent and received among the plurality of users as described above. After that, the control unit 21 refers to the vehicle dispatch service information provided by at least one vehicle dispatcher and, based on that information, creates vehicle dispatch plans each of which uses a vehicle dispatch service satisfying the vehicle dispatch requirements.

This embodiment makes it possible to provide a vehicle dispatch plan satisfying the user's requirements.

In this embodiment, the control unit 21 of the control device 20 refers to the vehicle dispatch service information provided by a plurality of vehicle dispatchers and, based on that information, creates vehicle dispatch plans, one for each of the plurality of vehicle dispatchers.

This embodiment makes it possible to provide a plurality of dispatch plans each of which satisfies user's requirements, giving the user a wider range of selections.

In one modification of this embodiment, the control unit 21 of the control device 20 may refer to the vehicle dispatch service information provided by a large number of vehicle dispatchers. In this case, for one of the large number of vehicle dispatchers or for each of several vehicle dispatchers, the control unit 21 of the control device 20 may create a vehicle dispatch plan. For example, by analyzing the content of a chat performed via a chat application that allows for the dispatch of a taxi via a chat, the control device 20 may select an appropriate vehicle dispatcher from the plurality of vehicle dispatchers and recommend the selected vehicle dispatcher to the user.

This modification eliminates the need for the user to select a vehicle dispatch plan.

In one modification of this embodiment, by referring to only the vehicle dispatch service information provided by one vehicle dispatcher, the control unit 21 of the control device 20 may create a vehicle dispatch plan for that one vehicle dispatcher.

In the example in FIG. 5 to FIG. 7, the vehicle dispatch requirements required by two users, user X and user Y, are detected based on two instant messages sent and received between the two user. However, the number of users is not limited to two but may be three or more and, similarly, the number of instant messages is not limited to two but may be one or may be three or more. The vehicle dispatch requirements are not limited to the requirements required by all users but may be the requirements required by at least one user. The plurality of users may include a vehicle dispatcher bot managed by at least one vehicle dispatcher.

In the example in FIG. 5 to FIG. 7, the vehicle dispatch of the vehicle 13 that transports two users, user X and user Y, is determined. However, the vehicle 13 is not limited to a vehicle that transports all users but may be a vehicle that transports at least one user.

In one modification of this embodiment, as the vehicle dispatch requirements required by at least one user, the control unit 21 of the control device 20 may detect a vehicle type required by the at least one user and, as the vehicle dispatch plan, may create a plan that uses the vehicle 13 of the detected vehicle type. In the example in FIG. 5 to FIG. 7, assume that additional instant messages indicating a desired vehicle type, such as “Because there is little baggage, a light vehicle taxi is desired” or “Because there is little baggage, a compact car is desired”, are sent and received between user X and user Y. In that case, the control unit 21 of the control device 20 reads the text such as “light vehicle” or “compact car” included in the instant messages additionally sent and received and, as a result, detects the vehicle type required by at least one of user X and user Y. After that, the control unit 21 creates a vehicle dispatch plan that uses the vehicle 13 of the detected vehicle type. For example, the control unit 21 creates a plan as vehicle dispatch plan P1. This created plan uses the vehicle dispatch service in FIG. 8 that is provided by vehicle dispatcher D1 that includes “light vehicle” as the vehicle type.

This modification makes it possible to provide a vehicle dispatch plan further satisfying the user's requirements.

In one modification of this embodiment, as the vehicle dispatch requirements required by at least one user, the control unit 21 of the control device 20 may detect the number of passengers required by the at least one user and, as the vehicle dispatch plan, may create a plan that uses the vehicle 13 that can carry the detected number of passengers. In the example in FIG. 5 to FIG. 7, assume that additional instant messages indicating the desired number of passengers, such as “let's go with you, mother, and me”, are sent and received between user X and user Y. In that case, the control unit 21 of the control device 20 reads the text such as “three persons” included in the instant messages additionally sent and received and, as a result, detects the number of passengers required by the at least one of user X and user Y. When there is no instant message additionally sent and received, the control unit 21 may count the number of a plurality of users participating in the chat and detect the counted value as the number of passengers. After that, the control unit 21 creates a vehicle dispatch plan that uses the vehicle 13 capable of carrying the detected number of passengers. For example, the control unit 21 creates two plans as vehicle dispatch plan P1 and vehicle dispatch plan P2, respectively. These created two plans use the vehicle dispatch services in FIG. 8 that are provided by vehicle dispatcher D1 and vehicle dispatcher D3 respectively and that include three or more as the number of passengers.

This modification makes it possible to provide a vehicle dispatch plan further satisfying the user's requirements.

In one modification of this embodiment, as the vehicle dispatch requirements required by at least one user, the control unit 21 of the control device 20 may detect a pick-up date required by the at least one user and, as the vehicle dispatch plan, may create a plan that carries at least one user on the pick-up date. In the example in FIG. 5 to FIG. 7, assume that additional instant messages indicating a desired pick-up date, such as “I hope it is sunny on December 1st”, are sent and received between user X and user Y. In that case, the control unit 21 of the control device 20 reads the text such as “December 1st” included in the instant messages additionally sent and received and, as a result, detects the desired pick-up date required by at least one of user X and user Y. After that, the control unit 21 creates a vehicle dispatch plan that carries at least one of user X and user Y on the detected pick-up date. For example, the control unit 21 creates a vehicle dispatch plan that uses a vehicle dispatch service in which December 1st is included in the vehicle dispatchable period.

This modification makes it possible to provide a vehicle dispatch plan further satisfying the user's requirements.

In one modification of this embodiment, the control unit 21 of the control device 20 may further detect a budget required by at least one user and, as the vehicle dispatch plan, may notify the at least one user of a plan in which the estimated amount is equal to or less than the budget. In the example in FIG. 5 to FIG. 7, assume that additional instant messages indicating a budget, such as “I have only 1,000 yen on hand”, are sent and received between user X and user Y. In that case, the control unit 21 of the control device 20 reads the text, such as “1,000 yen”, included in the instant messages additionally sent and received and, as a result, detects the budget required by at least one of user X and user Y. After that, the control unit 21 creates a vehicle dispatch plan in which the estimated amount is equal to or less than the detected budget. For example, the control unit 21 creates a vehicle dispatch plan that uses a vehicle dispatch service in which the estimated amount is equal to or less than 1,000 yen. As a further modification, when an additional instant message such as “I hope that the taxi fare should be cheaper” is sent and received, the control unit 21 may read the text “cheap” and estimate the budget.

This modification makes it possible to provide a vehicle dispatch plan further satisfying the user's requirements.

In one modification of this embodiment, the control unit 21 of the control device 20 may include, in a vehicle dispatch plan, the required time required by a vehicle dispatch service for carrying at least one user. In the example of FIG. 5 to FIG. 7, the control unit 21 of the control device 20 may calculate the required time based on the distance from station A to hotel B and include the calculated time in the vehicle dispatch plan.

This modification makes it possible to provide a vehicle dispatch plan further satisfying the user's requirements.

As a further modification, the control unit 21 of the control device 20 may further detect the arrival time required by at least one user and, as the vehicle dispatch plan, notify at least one user of a plan in which the required time is short enough for the vehicle to arrive earlier than the detected arrival time. In the example in FIG. 5 to FIG. 7, assume that additional instant messages indicating a desired arrival time, such as “the hotel event starts at 15:00”, are sent and received between user X and user Y. In that case, the control unit 21 of the control device 20 reads the text such as “15:00” included in the instant messages additionally sent and received and, as a result, detects the arrival time required by at least one of user X and user Y. After that, the control unit 21 creates a vehicle dispatch plan in which the required time is short enough for the vehicle to arrive earlier than the arrival time. For example, the control unit 21 first adds the required time, calculated based on the distance from station A to hotel B, to 12:40 that is the pick-up time and, then, creates a vehicle dispatch plan that uses a vehicle dispatch service in which the calculated time is earlier than the detected arrival time.

This modification makes it possible to provide a vehicle dispatch plan further satisfying the user's requirements.

In one modification of this embodiment, the control unit 21 of the control device 20 may select a vehicle dispatcher capable of dispatching the vehicle 13 that satisfies at least one user's requirements from a plurality of vehicle dispatchers and may recommend the selected vehicle dispatcher to the user.

This modification makes it possible to provide a vehicle dispatch plan further satisfying the user's requirements.

In one modification of this embodiment, one or more instant messages sent and received among a plurality of users may include an inquiry instant message and a response instant message. An inquiry instant message is an inquiry about vehicle dispatch requirements, and a response instant message is a response from at least one user to the inquiry message. When the response instant message is received, the control unit 21 of the control device 20 may detect vehicle dispatch requirements from the received response instant message. In the example of FIG. 5 to FIG. 7, the control unit 21 of the control device 20 may cause a vehicle dispatcher bot, which is a chat bot provided by at least one vehicle dispatcher, to interrupt a chat and may cause this chat bot to send an instant message, which includes a text such as “Please tell me your desired vehicle type”, as an inquiry instant message inquiring about the vehicle dispatch requirements. The control unit 21 or the control device 20 may read a text such as “I would like a light vehicle”, included in the response instant message that is a response from at least one user to the inquiry instant message, and may detect the vehicle type required by at least one of user X and user Y. In that case, the control unit 21 creates a vehicle dispatch plan that uses the vehicle 13 of the detected vehicle type. For example, the control unit 21 creates a plan as vehicle dispatch plan P1. This created plan uses the vehicle dispatch service in FIG. 8 that is provided by vehicle dispatcher D1 and that includes “light vehicle” as the vehicle type.

This modification allows vehicle dispatch requirements, required by at least one user, to be detected even when there is no chat that indicates vehicle dispatch requirements between users, making it possible to provide a vehicle dispatch plan further satisfying the user's requirements.

In this embodiment, the control unit 41 of the terminal device 40 receives the notification about a vehicle dispatch plan from the control device 20 and outputs the received notification.

This embodiment makes it possible to provide a vehicle dispatch plan satisfying the user's requirements.

In this embodiment, when a user operation to select a vehicle dispatch plan is received, the control unit 41 of the terminal device 40 sends a response to the control device 20 to indicate that the vehicle dispatch plan has been selected. When two or more vehicle dispatch plans are notified from the control device 20, the control unit 41 receives a user operation to select one of the two or more vehicle dispatch plans as the user operation. In response to this booking operation by user, the control device 20 sends a request for booking the vehicle dispatch plan to the vehicle dispatcher that provides the selected vehicle dispatch plan.

This embodiment can increase the convenience of the vehicle dispatch service.

In one modification of this embodiment, at least one of a plurality of users may freely enable or disable the vehicle dispatch necessity determination function or the vehicle dispatch plan proposal function. The “vehicle dispatch necessity determination function” refers to the function performed by the control unit 31 of the server device 30 to analyze the content of an instant message to determine whether vehicle dispatch is necessary, such as the processing performed in step S102 and step S105. The “vehicle dispatch plan proposal function” refers to the function performed by the control unit 21 of the control device 20 to detect vehicle dispatch requirements based on an instant message and to propose a vehicle dispatch plan that uses a vehicle dispatch service that satisfies the detected vehicle dispatch requirements, such as the processing performed in a series of steps from step S121 to step S127. For example, the user enables or disables the vehicle dispatch necessity determination function or the vehicle dispatch plan proposal function on the chat application setting screen or the like. When the vehicle dispatch necessity determination function is disabled by a user, the control unit 31 of the server device 30 does not analyze the instant messages of the user who has disabled the vehicle dispatch necessity determination function. When the vehicle dispatch plan proposal function is disabled by a user, the control unit 21 of the control device 20 does not analyze the instant messages of the user who has disabled the vehicle dispatch plan proposal function. Alternatively, when at least one of a plurality of users participating in a chat has disabled the vehicle dispatch necessity determination function, the control unit 31 of the server device 30 does not determine the vehicle dispatch necessity for any of the instant messages sent and received in the chat. When at least one of a plurality of users participating in a chat has disabled the vehicle dispatch plan proposal function, the control unit 21 of the control device 20 neither detect vehicle dispatch requirements nor propose a vehicle dispatch plan for any instant message sent and received in the chat.

This modification allows the user to freely enable or disable the vehicle dispatch necessity determination function or the vehicle dispatch plan proposal function, making it possible to freely select whether to permit analysis of his/her instant messages. For example, a user who is reluctant to have his/her instant messages analyzed may disable the vehicle dispatch necessity determination function or the vehicle dispatch plan proposal function to prevent his/her instant messages from being analyzed.

In one modification of this embodiment, the server device 30 may be integrated into the control device 20.

The present disclosure is not limited to the above embodiment. For example, a plurality of blocks included in the block diagram may be integrated, or one block may be divided. Instead of performing the steps shown in the flowchart in chronological order according to the description, the steps may be performed in parallel or in a different order as necessary depending on the processing capability of the device that performs the steps. Other changes may be made without departing from the spirit of the present disclosure.

What is claimed is:

1. A control device comprising a control unit configured to detect vehicle dispatch requirements based on one or more instant messages sent and received among a plurality of users and is configured to create a vehicle dispatch plan that uses a vehicle dispatch service that satisfies the vehicle dispatch requirements by referring to vehicle dispatch service information, the vehicle dispatch requirements being required by at least one user of the plurality of users, the vehicle dispatch service information being provided by at least one vehicle dispatcher.

2. The control device according to claim 1, wherein the control unit is configured to create the vehicle dispatch plan for each of a plurality of vehicle dispatchers by referring to vehicle dispatch service information provided by the plurality of vehicle dispatchers.

3. The control device according to claim 1, wherein the control unit is configured to detect a vehicle type required by the at least one user as the vehicle dispatch requirements and is configured to create a plan that uses a vehicle of the vehicle type as the vehicle dispatch plan.

4. The control device according to claim 1, wherein the control unit is configured to detect the number of passengers required by the at least one user as the vehicle dispatch requirements and is configured to create a plan that uses a vehicle capable of carrying the number of passengers as the vehicle dispatch plan.

5. The control device according to claim 4, wherein the control unit is configured to count the number of the plurality of users and is configured to detect a resulting counted value as the number of passengers.

6. The control device according to claim 1, wherein the control unit is configured to detect a pick-up place required by the at least one user as the vehicle dispatch requirements and is configured to create a plan that carries the at least one user from the pick-up place as the vehicle dispatch plan.

7. The control device according to claim 1, wherein the control unit is configured to detect a pick-up date required by the at least one user as the vehicle dispatch requirements and is configured to create a plan that carries the at least one user on the pick-up date as the vehicle dispatch plan.

8. The control device according to claim 1, wherein the control unit is configured to detect a pick-up time required by the at least one user as the vehicle dispatch requirements and is configured to create a plan that starts carrying the at least one user at the pick-up time as the vehicle dispatch plan.

9. The control device according to claim 1, wherein the control unit is configured to detect a drop-off place required by the at least one user as the vehicle dispatch requirements and is configured to create a plan that carries the at least one user to the drop-off place as the vehicle dispatch plan.

10. The control device according to claim 1, wherein the control unit is configured to include, in the vehicle dispatch plan, an estimated amount of fare of the vehicle dispatch service that satisfies the vehicle dispatch requirements.

11. The control device according to claim 10, wherein the control unit is further configured to detect a budget required by the at least one user and is configured to notify the at least one user of a plan in which the estimated amount is equal to or less than the budget as the vehicle dispatch plan.

12. The control device according to claim 1, wherein the control unit is configured to include, in the vehicle dispatch plan, a required time required to carry the at least one user by the vehicle dispatch service.

13. The control device according to claim 12, wherein the control unit is further configured to detect an arrival time required by the at least one user and is configured to notify the at least one user of a plan in which the required time is short enough for the vehicle to arrive earlier than the arrival time as the vehicle dispatch plan.

14. The control device according to claim 1, wherein:
the one or more instant messages include an inquiring instant message for inquiring about the vehicle dispatch requirements and a responding instant message from the at least one user for responding to the inquiring instant message; and
the control unit is configured to detect the vehicle dispatch requirements from the responding instant message.

15. A system comprising:
the control device according to claim 1; and
terminal devices of the plurality of users.

16. A program that causes a computer to perform an operation, wherein the operation includes:
receiving a vehicle dispatch plan notification from a control device, wherein the control device is configured to detect vehicle dispatch requirements based on one or more instant messages sent and received among a plurality of users and is configured create a vehicle dispatch plan that uses a vehicle dispatch service that satisfies the vehicle dispatch requirements by referring to vehicle dispatch service information, the vehicle dispatch requirements being required by at least one user of the plurality of users, the vehicle dispatch service information being provided by at least one vehicle dispatcher; and
outputting the received notification.

17. The program according to claim 16, wherein the operation further includes:
when a user operation to select the vehicle dispatch plan is received, sending a response indicating that the vehicle dispatch plan is selected; and
when two or more vehicle dispatch plans are notified from the control device, receiving an operation to select one of the two or more vehicle dispatch plans as the user operation.

18. A terminal device configured to perform the operation according to the program according to claim 16.

19. A control method comprising:
detecting, by a control device, vehicle dispatch requirements based on one or more instant messages sent and received among a plurality of users, the vehicle dispatch requirements being required by at least one user of the plurality of users; and
creating, by the control device, a vehicle dispatch plan that uses a vehicle dispatch service that satisfies the vehicle dispatch requirements by referring to vehicle dispatch service information, the vehicle dispatch service information being provided by at least one vehicle dispatcher.

20. The control method according to claim 19, the control method further comprising:
when a user operation to select the vehicle dispatch plan is received, sending, by a terminal device of the at least one user, a response indicating that the vehicle dispatch plan is selected; and
when two or more vehicle dispatch plans are created by the control device, receiving, by the terminal device of the at least one user, an operation to select one of the two or more vehicle dispatch plans as the user operation.
